(19) United States
(12) Patent Application Publication
(10) Pub. No.: US 2025/0246156 A1
(43) Pub. Date: Jul. 31, 2025

(54) DISPLAY DEVICE

(71) Applicant: Samsung Display Co., LTD., Yongin-si (KR)

(72) Inventors: Chan Keun KWON, Yongin-si (KR); Dong Wan HA, Yongin-si (KR); Jun Soo KO, Yongin-si (KR); Mun Gyu KIM, Yongin-si (KR); Hyung Seup KIM, Yongin-si (KR); Gi Chang LEE, Yongin-si (KR)

(21) Appl. No.: 18/986,483

(22) Filed: Dec. 18, 2024

(30) Foreign Application Priority Data
Jan. 30, 2024 (KR) 10-2024-0014225
Apr. 8, 2024 (KR) 10-2024-0047266

(51) Int. Cl. G09G 3/3275; G09G 3/3266

(52) U.S. Cl. CPC G09G 3/3275; G09G 3/3266; G09G 2310/0289; G09G 2330/021

(57) ABSTRACT

A display device includes: a substrate including a display panel configured to display an image corresponding to image data, a data driver configured to apply a plurality of data signals corresponding to the image data to the display panel, a level shifter configured to change a voltage level of the image data, and first pads; and a control substrate including a controller configured to output the image data to the level shifter, and attached to the substrate in a vertical direction through the first pads.

### CROSS-REFERENCE TO RELATED APPLICATION

The present application claims priority to and the benefit of Korean Patent Application No. 10-2024-0014225 filed in the Korean Intellectual Property Office on Jan. 30, 2024, and Korean Patent Application No. 10-2024-0047266 filed in the Korean Intellectual Property Office on Apr. 8, 2024, the entire disclosure of which is incorporated herein by reference.

### BACKGROUND

### 1. Field

Aspects of some embodiments of the present disclosure relate to a display device.

### 2. Description of the Related Art

As information technology develops, the importance of display devices, which provide a connection medium between users and information, is emerging. Accordingly, the use of display devices such as liquid crystal display devices, organic light emitting display devices, and inorganic light emitting display devices is increasing.

The display device may include a display panel on which images are displayed and a controller that controls the display panel. Various methods that connect a substrate including the display panel and a substrate including the controller may be provided.

The above information disclosed in this Background section is only for enhancement of understanding of the background and therefore the information discussed in this Background section does not necessarily constitute prior art.

### SUMMARY

Aspects of some embodiments of the present disclosure include a display device including a substrate including a display panel and a substrate including a controller.

According to some embodiments of the present disclosure, a display device includes: a substrate including a display panel that displays an image corresponding to image data, a data driver that applies a plurality of data signals corresponding to the image data to the display panel, a level shifter that changes a voltage level of the image data, and first pads; and a controller that outputs the image data to the level shifter, and a control substrate attached to the substrate in a vertical direction through the first pads.

According to some embodiments, the data driver and the level shifter may be configured as one integrated circuit.

According to some embodiments, the substrate may further include a gate driver that applies a plurality of gate signals to the display panel.

According to some embodiments, the substrate may include a display area in which the display panel is located and a non-display area in which the first pads, the data driver, the gate driver, and the level shifter are located.

According to some embodiments, the first pads, the level shifter, and the data driver may be on a first side surface of the display panel, the gate driver may be on a second side surface of the display panel, and the first side surface and the second side surface may be perpendicular to each other.

According to some embodiments, the first pads, the level shifter, and the gate driver may be on a first side surface of the display panel, the data driver may be on a second side surface of the display panel, and the first side surface and the second side surface may be perpendicular to each other.

According to some embodiments, the gate driver may include a first sub-gate driver and a second sub-gate driver, the first pads, the level shifter, and the first sub-gate driver may be on the first side surface, the data driver may be on the second side surface, the second sub-gate driver may be on a third side surface of the display panel, the second side surface and the third side surface may be perpendicular to each other, and the first side surface and the third side surface may be parallel to each other.

According to some embodiments, the data driver may include a sampling latch and a holding latch, and the image data may be outputted to the display panel through the level shifter, the sampling latch, and the holding latch in that order.

According to some embodiments, the image data outputted by the controller to the level shifter may be a digital signal.

According to some embodiments, the control substrate may be formed as a silicon wafer substrate.

According to some embodiments of the present disclosure, a display device includes: a substrate including a display panel displaying an image corresponding to image data, and first pads on the first side surface of the display panel; and a control substrate including a data driver that applies a plurality of data signals corresponding to the image data to the display panel and a controller that outputs the image data to the data driver, wherein the control substrate is attached to the substrate in a vertical direction through the first pads, the gate driver is on a second side surface of the display panel, and the first side surface and the second side surface are perpendicular to each other.

According to some embodiments, the control substrate may be formed as a silicon wafer substrate.

According to some embodiments, the controller and the data driver may be configured as one integrated circuit.

According to some embodiments, the substrate may further includes a gate driver that applies a plurality of gate signals to the display panel.

According to some embodiments, the substrate may include a display area in which the display panel is located and a non-display area in which the first pads and the gate driver are located.

According to some embodiments, the substrate may further include a level shifter, the data driver may include a sampling latch and a holding latch, and the image data may be outputted to the display panel through the sampling latch, the holding latch, and the level shifter in that order.

According to some embodiments of the present disclosure, a display device includes: a substrate including a display panel that displays an image corresponding to image data and a data driver that applies a plurality of data signals corresponding to the image data to the display panel; a control circuit board that includes a controller that outputs the image data to the data driver; and a connection circuit board that connects the substrate and the control circuit board.

According to some embodiments, the substrate may further include first pads, the control circuit board may further include second pads, and one end of the connection circuit board may be connected to the first pads and the other end of the connection circuit board may be connected to the second pads.

According to some embodiments, the control circuit board may be formed as a silicon wafer substrate.

According to some embodiments, the control circuit board may be a printed circuit board, and the connection circuit board may be a flexible circuit board.

In a display device according to some embodiments of the present disclosure, design freedom may be relatively improved, and power consumption may be relatively reduced.

### BRIEF DESCRIPTION OF THE DRAWINGS

FIG. 1 illustrates a block diagram of a display device according to some embodiments.

FIG. 2 illustrates a top plan view of embodiments of a display panel of FIG. 1.

FIG. 3 illustrates an exploded perspective view of a portion of the display panel of FIG. 2.

FIG. 4 illustrates a block diagram of a connection relationship between a substrate and a controller according to some embodiments.

FIG. 5 illustrates a top plan view of embodiments of FIG. 4.

FIG. 6 illustrates a cross-sectional view of embodiments of FIG. 4.

FIG. 7 illustrates a block diagram of a connection relationship between a substrate and a controller according to some embodiments.

FIG. 8 illustrates a top plan view of embodiments of FIG. 7.

FIG. 9 illustrates a cross-sectional view of embodiments of FIG. 7.

FIG. 10 illustrates a block diagram of a connection relationship between a substrate and a controller according to some embodiments.

FIG. 11 illustrates a top plan view of embodiments of FIG. 10.

FIG. 12 illustrates a cross-sectional view of embodiments of FIG. 10.

FIG. 13 illustrates a block diagram of a connection relationship between a substrate and a controller according to some embodiments.

FIG. 14 illustrates a cross-sectional view of embodiments of FIG. 13.

FIG. 15 illustrates a block diagram of a connection relationship between a substrate and a controller according to some embodiments.

FIG. 16 illustrates a cross-sectional view of embodiments of FIG. 15.

FIG. 17 illustrates a block diagram of a display system according to some embodiments.

FIG. 18 illustrates a perspective view of an application example of the display system of FIG. 17.

FIG. 19 illustrates a head-mounted display device worn on a user of FIG. 18.

### DETAILED DESCRIPTION

Hereinafter, aspects o some embodiments of the present disclosure will be described in more detail with reference to the accompanying drawings. The following description is intended to provide only a sufficient disclosure to enable the understanding of the operation of the invention, and any other disclosure is omitted to avoid obscuring the scope of the invention. In addition, the inventive concept may be embodied in different forms and is not limited to the embodiments set forth herein. The embodiments described herein are provided for the purpose of describing the technical concept of the invention in sufficient detail for those skilled in the art to easily practice it.

Throughout the specification, when it is described that an element is “connected” to another element, this includes not only being “directly connected”, but also being “indirectly connected” with another device in between. The terms used herein are for the purpose of describing specific embodiments and are not intended to limit the scope of the invention. Throughout the specification, unless explicitly described to the contrary, the word “comprise” and variations such as “comprises” or “comprising” will be understood to imply the inclusion of stated elements but not the exclusion of any other elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms first, second, etc. may be used herein to describe various constituent elements, these constituent elements should not be limited by these terms. These terms are used to distinguish one constituent element from another. Thus, a first constituent element discussed below could be termed a second constituent element without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (for example, rotated 90 degrees or at other orientations), and, as such, the spatially relative descriptors used herein interpreted accordingly.

Various embodiments are described herein with reference to sectional illustrations that are schematic illustrations of idealized embodiments. As such, variations from the shapes of the illustrations as a result, for example, of manufacturing techniques and/or tolerances, are to be expected. Thus, embodiments disclosed herein should not be construed as limited to the particular illustrated shapes of regions, but are to include deviations in shapes that result from, for instance, manufacturing. Thus, the regions illustrated in the drawings are schematic in nature and their shapes are not intended to illustrate the actual shape of a region of a device and are not intended to be limiting.

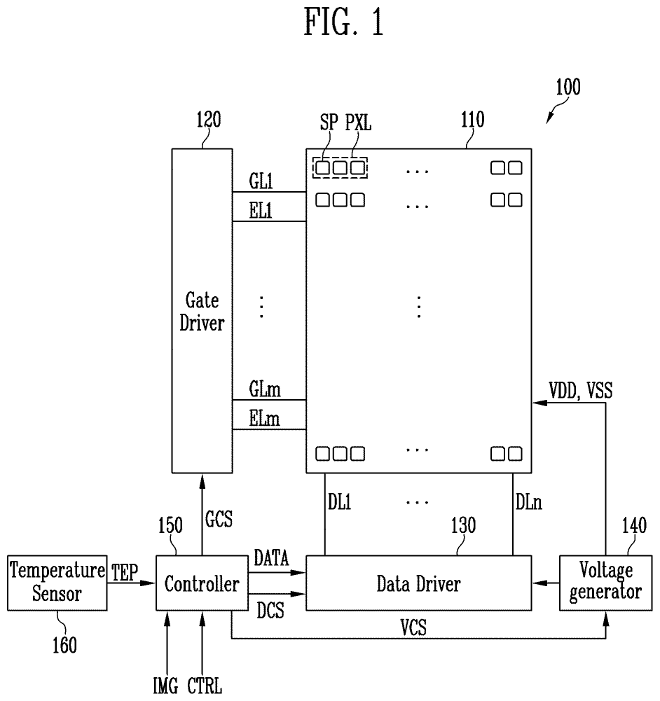

FIG. 1 illustrates a block diagram of a display device according to some embodiments.

Referring to FIG. 1, a display device 100 may include a display panel 110, a gate driver 120, a data driver 130, a voltage generator 140, and a controller 150.

The display panel 110 includes sub-pixels SP. The sub-pixels SP may be connected to the gate driver 120 through first to m-th gate lines GL1 to GLm. The sub-pixels SP may be connected to the data driver 130 through first to n-th data lines DL1 to DLn.

Each of the sub-pixels SP may include at least one light emitting element configured to generate light. Accordingly, the sub-pixels SP may respectively generate light of a specific color, such as red, green, blue, cyan, magenta, yellow, or the like. Two or more of the sub-pixels SP may configure one pixel PXL. For example, as shown in FIG. 1, three sub-pixels may configure one pixel PXL.

The gate driver 120 is connected to the sub-pixels SP arranged in a row direction through the first to m-th gate lines GL1 to GLm. The gate driver 120 may output gate signals to the first to m-th gate lines GL1 to GLm in response to a gate control signal GCS. According to some embodiments, the gate control signal GCS may include a start signal indicating the start of each frame, a horizontal synchronization signal for outputting gate signals in synchronization with the timing at which data signals are applied, and the like.

In some embodiments, first to m-th light emitting control lines EL1 to ELm connected to the sub-pixels SP in a row direction may be further provided. In this case, the gate driver 120 may include a light emitting control driver configured to control the first to m-th light emitting control lines EL1 to ELm, and the light emitting control driver may operate under the control of the controller 150.

The gate driver 120 may be located on one side of the display panel 110. However, embodiments are not limited thereto. For example, the gate driver 120 may be divided into two or more physically and/or logically separated drivers, and the drivers may be located on one side of the display panel 110 and the other side of the display panel 110 opposite to the one side. As described above, the gate driver 120 may be arranged around the display panel 110 in various forms according to the embodiments.

The data driver 130 is connected to the sub-pixels SP arranged in a column direction through the first to n-th data lines DL1 to DLn. The data driver 130 receives image data (DATA) and data control signal DCS from the controller 150. The data driver 130 operates in response to the data control signal DCS. According to some embodiments, the data control signal DCS may include a source start pulse, a source shift clock, a source output enable signal, and the like.

The data driver 130 may use voltages from the voltage generator 140 to apply data signals having grayscale voltages corresponding to the image data (DATA) to the first to n-th data lines DL1 to DLn. When a gate signal is applied to each of the first to m-th gate lines GL1 to GLm, data signals corresponding to the image data DATA may be applied to the data lines DL1 to DLm. Accordingly, the corresponding sub-pixels SP may generate light corresponding to the data signals. Accordingly, an image is displayed on the display panel 110.

According to some embodiments, the gate driver 120 and the data driver 130 may include complementary metal-oxide semiconductor (CMOS) circuit elements.

The voltage generator 140 may operate in response to a voltage control signal VCS from the controller 150. The voltage generator 140 is configured to generate a plurality of voltages and provide the generated voltages to constituent elements of the display device 100. For example, the voltage generator 140 may be configured to generate a plurality of voltages by receiving an input voltage from the outside of the display device 100, adjusting the received voltage, and regulating the adjusted voltage.

The voltage generator 140 may generate a first power voltage VDD and a second power voltage VSS, and the generated first and second power voltages VDD and VSS may be provided to the sub-pixels SP. The first power voltage VDD may have a relatively high voltage level, and the second power voltage VSS may have a voltage level lower than the first power voltage VDD. According to some embodiments, the first power voltage VDD or the second power voltage VSS may be provided by an external device of the display device 100.

In addition, the voltage generator 140 may generate various voltages. For example, the voltage generator 140 may generate an initialization voltage applied to the sub-pixels SP. For example, during a sensing operation to sense electrical characteristics of transistors and/or light emitting elements of the sub-pixels SP, a reference voltage (e.g., a set or predetermined reference voltage) may be applied to the first to n-th data lines DL1 to DLn, and the voltage generator 140 may generate the reference voltage.

The controller 150 controls various operations of the display device 100. The controller 150 receives input image data IMG and a control signal CTRL for controlling the display of the input image data, from the outside. The controller 150 may provide the gate control signal GCS, the data control signal DCS, and the voltage control signal VCS in response to the control signal CTRL.

The controller 150 may convert the input image data IMG to be suitable for the display device 100 or the display panel 110 to output the image data DATA. According to some embodiments, the controller 150 may output the image data DATA by aligning the input image data IMG to be suitable for the sub-pixels SP of a row unit.

Two or more components of the data driver 130, the voltage generator 140, and the controller 150 may be configured as one integrated circuit.

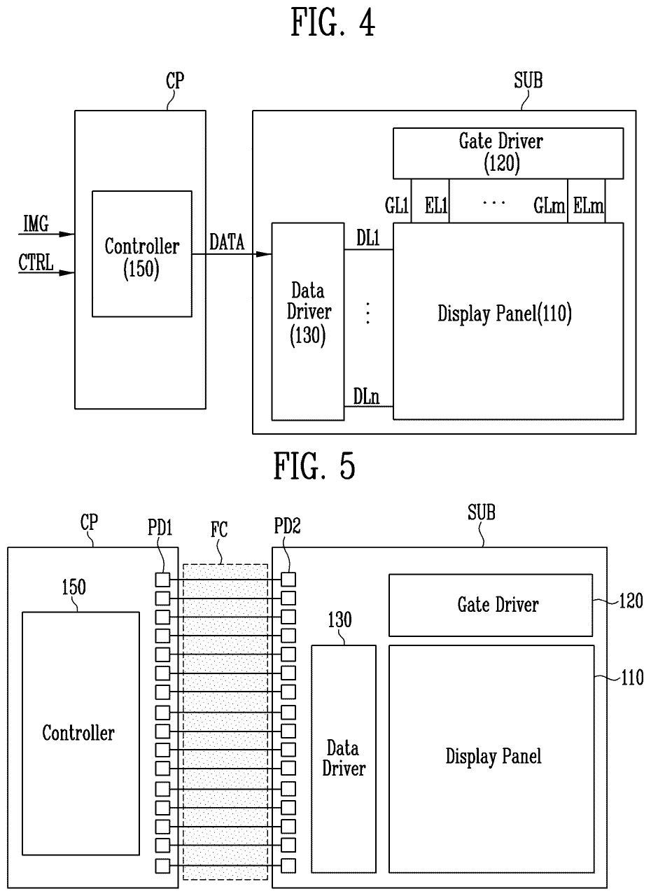

According to some embodiments, the controller 150 may be configured as one integrated circuit and located on a printed circuit board (PCB). This will be described in more detail later with reference to FIG. 4 to FIG. 6.

According to some embodiments, the data driver 130 and the controller 150 may be configured as one integrated circuit and located on a control substrate. In this case, the data driver 130 and controller 150 may be functionally separate components within one integrated circuit. This will be described in more detail later with reference to FIG. 7 to FIG. 9.

According to some embodiments, the controller 150 may be configured as one integrated circuit and located on a control substrate. This will be described in more detail later with reference to FIG. 10 to FIG. 16.

The display device 100 may include at least one temperature sensor 160. The temperature sensor 160 is configured to sense a surrounding temperature and generate temperature data TEP representing the sensed temperature.

The controller 150 may control various operations of the display device 100 in response to the temperature data TEP. According to some embodiments, the controller 150 may adjust the luminance of an image outputted from the display panel 110 in response to the temperature data TEP. For example, the controller 150 may control the data signals and the first and second power voltages VDD and VSS by controlling components such as the data driver 130 and/or the voltage generator 140.

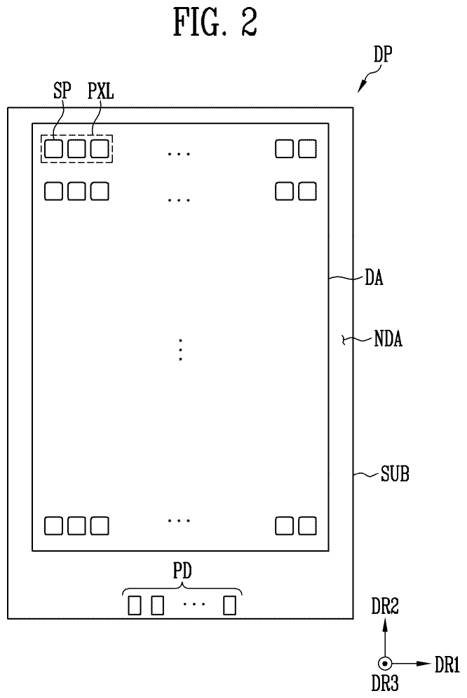

FIG. 2 illustrates a top plan view of a display panel of FIG. 1 according to some embodiments.

Referring to FIG. 2, an example display panel DP of the display panel 110 of FIG. 1 may include a display area DA and a non-display area NDA. The display panel DP displays images at the display area DA. The non-display area NDA is arranged around (e.g., in a periphery or outside a footprint of) the display area DA.

The display panel DP may include a substrate SUB, sub-pixels SP, and pads PD.

When the display panel DP is used as a display screen for a head mounted display (HMD), a virtual reality (VR) device, a mixed reality (MR) device, or an augmented reality (AR) device, the display panel DP may be positioned very close to the user's eyes. In this case, the sub-pixels SP with relatively high integration are required. In order to increase the integration of the sub-pixels SP, the substrate SUB may be provided as a silicon substrate. The sub-pixels SP and/or the display panel DP may be formed on the substrate SUB, which is a silicon substrate. The display device 100 (see FIG. 1) including the display panel DP formed on the substrate SUB, which is a silicon substrate, may be referred to as an OLED on silicon (OLEDoS) display device.

The sub-pixels SP are located in the display area DA on the substrate SUB. The sub-pixels SP may be arranged in a matrix format along a first direction DR1 and a second direction DR2 that intersects the first direction DR1. However, embodiments are not limited thereto. For example, the sub-pixels SP may be arranged in a zigzag form along first direction DR1 and second direction DR2. For example, the sub-pixels SP may be arranged in a PENTILE™ shape. The first direction DR1 may be a row direction, and the second direction DR2 may be a column direction.

Two or more of the plurality of sub-pixels SP may configure one pixel PXL.

A constituent element to control the sub-pixels SP may be located in the non-display area NDA on the substrate SUB. For example, wires connected to the sub-pixels SP, such as the first to m-th gate lines GL1 to GLm and the first to n-th data lines DL1 to DLn of FIG. 1, may be located in the non-display area NDA.

At least one of the gate driver 120, the data driver 130, the voltage generator 140, and the temperature sensor 160 in FIG. 1 may be integrated in the non-display area NDA of the display panel DP. According to some embodiments, the gate driver 120 of FIG. 1 may be mounted on the display panel DP, and may be located in the non-display area NDA. According to some embodiments, the gate driver 120 may be implemented as an integrated circuit separated from the display panel DP. According to some embodiments, the temperature sensor 160 may be located in the non-display area NDA to detect the temperature of the display panel DP.

The pads PD are located in the non-display area NDA on the substrate SUB. The pads PD may be electrically connected to the sub-pixels SP through wires. For example, the pads PD may be connected to the sub-pixels SP through the first to n-th data lines DL1 to DLn.

The pads PD may interface the display panel DP to other constituent elements of the display device 100 (see FIG. 1). According to some embodiments, voltages and signals required for operations of constituent elements included in the display panel DP may be provided from the controller 150 of FIG. 1 through the pads PD. For example, the first to n-th data lines DL1 to DLn may be connected to a control substrate or printed circuit board on which the controller 150 is mounted through the pads PD.

According to some embodiments, the display area DA may have various shapes. The display area DA may have a closed-loop shape including sides of a straight line and/or a curved line. For example, the display area DA may have shapes such as a polygonal shape, a circular shape, a semicircular, and an elliptical shape.

According to some embodiments, the display panel DP may have a flat display surface. According to some embodiments, the display panel DP may have a display surface that is at least partially round. According to some embodiments, the display panel DP may be bendable, foldable, or rollable. In these cases, the display panel DP and/or the substrate SUB may include materials with flexible properties.

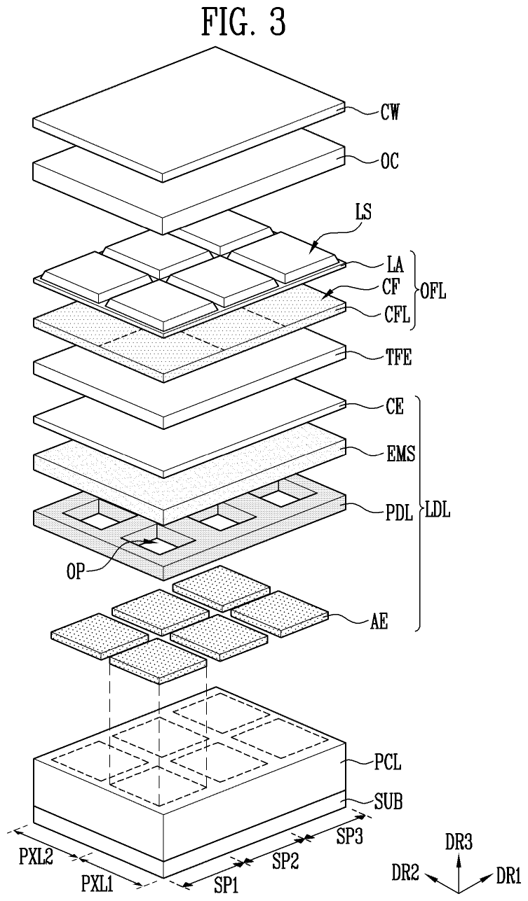

FIG. 3 illustrates an exploded perspective view of a portion of the display panel of FIG. 2. In FIG. 3, for clear and concise description, a portion of the display panel DP corresponding to two pixels PXL1 and PXL2 among the pixels PXL of FIG. 2 is schematically shown. Portions of the display panel DP corresponding to the remaining pixels may be similarly configured.

Referring to FIG. 2 and FIG. 3, each of the first and second pixels PXL1 and PXL2 may include first to third sub-pixels SP1, SP2, and SP3. However, embodiments are not limited thereto. For example, each of the first and second pixels PXL1 and PXL2 may include four sub-pixels, or two sub-pixels.

In FIG. 3, the first to third sub-pixels SP1, SP2, and SP3 are shown to have quadrangular shapes and have the same sizes when viewed in the third direction DR3 crossing the first and second directions DR1 and DR2 (e.g., in a plan view). However, embodiments are not limited thereto. The first to third sub-pixels SP1, SP2, and SP3 may be modified to have various shapes.

The display panel DP may include a substrate SUB, a pixel circuit layer PCL, a light emitting element layer LDL, an encapsulation layer TFE, an optical functional layer OFL, an overcoat layer OC, and a cover window CW.

According to some embodiments, the substrate SUB may include a silicon wafer substrate formed using a semiconductor process. The substrate SUB may include a semiconductor material suitable for forming circuit elements. For example, the semiconductor material may include silicon, germanium, and/or silicon-germanium.

The substrate SUB may be provided from a bulk wafer, an epitaxial layer, an epitaxial layer, a silicon on Insulator (SOI) layer, or a semiconductor on insulator (SeOI) layer. According to some embodiments, the substrate SUB may include a glass substrate. In still other embodiments, the substrate SUB may include a polyimide (PI) substrate.

The pixel circuit layer PCL is located on the substrate SUB. The substrate SUB and/or the pixel circuit layer PCL may include insulating layers and conductive patterns located between the insulating layers. The conductive patterns of the pixel circuit layer PCL may function as at least some of circuit elements, wires, and the like

The conductive patterns may include copper, but embodiments are not limited thereto.

The circuit elements may include the sub-pixel circuit for each of first to third sub-pixels SP1, SP2, and SP3. The sub-pixel circuit may include transistors and one or more capacitors. Each transistor may include a semiconductor portion including a source region, a drain region, and a channel region, and a gate electrode overlapping the semiconductor portion. According to some embodiments, when the substrate SUB is provided as a silicon substrate, the semiconductor portion may be included in the substrate SUB, and the gate electrode may be included in the pixel circuit layer PCL as the conductive pattern of the pixel circuit layer PCL. According to some embodiments, when the substrate SUB is provided as a glass substrate or a PI substrate, the semiconductor portion and the gate electrode may be included in the pixel circuit layer PCL. Each capacitor may include electrodes spaced apart from each other. For example, each capacitor may include electrodes spaced apart from each other on a plane defined by the first and second directions DR1 and DR2. For example, each capacitor may include electrodes spaced apart from each other in the third direction DR3 with an insulating layer therebetween.

The wires of the pixel circuit layer PCL may include signal lines connected to each of the first to third sub-pixels SP1, SP2, and SP3 for example, a gate line, a light emitting control line, and a data line. The wires may further include a wire providing the first power voltage VDD of FIG. 1. In addition, the wires may further include a wire providing the second power voltage VSS of FIG. 1.

The light emitting element layer LDL may include anode electrodes AE, a pixel defining film PDL, a light emitting structure EMS, and a cathode electrode CE.

The anode electrodes AE may be located on the pixel circuit layer PCL. The anode electrodes AE may contact circuit elements of the pixel circuit layer PCL. The anode electrodes AE may include an opaque conductive material capable of reflecting light, but embodiments are not limited thereto.

The pixel defining film PDL is located on the anode electrodes AE. The pixel defining film PDL may include an opening OP exposing a portion of each of the anode electrodes AE. The opening OP of the pixel defining film PDL may be understood as light emitting areas corresponding to the first to third sub-pixels SP1 to SP3, respectively.

According to some embodiments, the pixel defining film PDL may include an inorganic material. In this case, the pixel defining film PDL may include a plurality of stacked inorganic layers. For example, the pixel defining film PDL may include a silicon oxide (SiOx) and a silicon nitride (SiNx). According to some embodiments, the pixel defining film PDL may include an organic material. However, the material of the pixel defining film PDL is not limited thereto.

The light emitting structure EMS may be located on the anode electrodes AE exposed by the opening OP of the pixel defining film PDL. The light emitting structure EMS may include a light emitting layer configured to generate light, an electron transport layer configured to transport electrons, and a hole transport layer configured to transport holes.

According to some embodiments, the light emitting structure EMS may fill the opening OP of the pixel defining film PDL, and may be arranged entirely on an upper portion of the pixel defining film PDL. In other words, the light emitting structure EMS may extend across the first to third sub-pixels SP1 to SP3. In this case, at least some of the functional layers in the light emitting structure EMS may be disconnected or bent at the boundaries between the first to third sub-pixels SP1 to SP3. However, embodiments are not limited thereto. For example, portions of the light emitting structure EMS corresponding to the first to third sub-pixels SP1 to SP3 are separated from each other, and each of them may be located in the opening OP of the pixel defining film PDL.

The cathode electrode CE may be located on the light emitting structure EMS. The cathode electrode CE may extend across the first to third sub-pixels SP1 to SP3. As such, the cathode electrode CE may be provided as a common electrode for the first to third sub-pixels SP1 to SP3.

The cathode electrode CE may be a thin metal layer with a thickness sufficient to transmit light emitted from the light emitting structure EMS. The cathode electrode CE may be made of a metallic material or a transparent conductive material to have a relatively thin thickness. According to some embodiments, the cathode electrode CE may include at least one of various transparent conductive materials including an indium tin oxide, an indium zinc oxide, an indium tin zinc oxide, an aluminum zinc oxide, a gallium zinc oxide, a zinc tin oxide, and a gallium tin oxide. According to some embodiments, the cathode electrode CE may include at least one of silver (Ag), magnesium (Mg), and a mixture thereof. However, the material of the cathode electrode CE is not limited thereto.

One of the anode electrodes AE, the portion of the light emitting structure EMS overlapping it, and the portion of the cathode electrode CE overlapping it may be understood to configure one light emitting element. In other words, each of the light emitting elements of the first to third sub-pixels SP1 to SP3 may include one anode electrode, a portion of the light emitting structure EMS overlapping it, and a portion of the cathode electrode CE overlapping it. In each of the first to third sub-pixels SP1 to SP3, holes injected from the anode electrode AE and electrons injected from the cathode electrode CE are transported into the light emitting layer of the light emitting structure EMS to form excitons, and when the excitons transition from the excited state to the ground state, light may be generated. The luminance of light may be determined depending on the amount of current flowing through the light emitting layer. Depending on the configuration of the light emitting layer, the wavelength range of the generated light may be determined.

The encapsulation layer TFE is located on the cathode electrode CE. The encapsulation layer TFE may cover the light emitting element layer LDL and/or the pixel circuit layer PCL. The encapsulation layer TFE may be configured to prevent or reduce instances of contaminants such as oxygen and/or moisture penetrating into the light emitting element layer LDL. According to some embodiments, the encapsulation layer TFE may include a structure in which one or more inorganic films and one or more organic films are alternately stacked. For example, the inorganic film may include a silicon nitride, a silicon oxide, or a silicon oxynitride (SiOxNy). For example, the organic film may include an organic insulating material such as an acrylic resin, an epoxy resin, a phenol resin, a polyamide resin, a polyimide resin, an unsaturated polyesters resin, a polyphenylenethers resin, a polyphenylenesulfides resin, or a benzocyclobutene. However, the materials of the organic film and the inorganic film of the encapsulation layer TFE are not limited thereto.

The encapsulation layer TFE may further include a thin film containing an aluminum oxide (AlOx) in order to relatively improve the encapsulation efficiency of the encapsulation layer TFE. The thin film containing an aluminum oxide may be located on the upper surface of the encapsulation layer TFE facing the optical functional layer OFL and/or the lower surface of the encapsulation layer TFE facing the light emitting element layer LDL.

The thin film containing the aluminum oxide may be formed through atomic layer deposition (ALD). However, embodiments are not limited thereto. The encapsulation layer TFE may further include a thin film made of at least one of various materials suitable for relatively improving the encapsulation efficiency.

The optical functional layer OFL is located on the encapsulation layer TFE. The optical function layer OFL may include a color filter layer CFL and a lens array LA.

The color filter layer CFL is located between the encapsulation layer TFE and the lens array LA. The color filter layer CFL is configured to selectively output light in a wavelength range or color corresponding to each sub-pixel by filtering light emitted from the light emitting structure EMS. The color filter layer CFL includes color filters CF respectively corresponding to the first to third sub-pixels SP1 to SP3), and each of the color filters CF may pass light in a wavelength range corresponding to the sub-pixel. For example, a color filter corresponding to the first sub-pixel SP1 may pass red light, a color filter corresponding to the second sub-pixel SP2 may pass green light, and a color filter corresponding to the third sub-pixel SP3 may pass blue light. At least some of the color filters CF may be omitted according to light emitted from the light emitting structure EMS of each sub-pixel.

The lens array LA is located on the color filter layer CFL. The lens array LA may include lenses LS respectively corresponding to the first to third sub-pixels SP1 to SP3. Each of the lenses LS may relatively improve light output efficiency by outputting light emitted from the light emitting structure EMS in an intended path. The lens array LA may have a relatively high refractive index. For example, the lens array LA may have a higher refractive index than the overcoat layer OC. According to some embodiments, the lenses LS may include an organic material. According to some embodiments, the lenses LS may include an acrylic material. However, the material of the lenses LS is not limited thereto.

According to some embodiments, compared to the opening OP of the pixel defining film PDL, at least some of the color filters CF of the color filter layer CF and at least some of the lenses LS of the lens array LA may be shifted in a direction parallel to a plane defined by the first and second directions DR1 and DR2. Specifically, in the center area of the display area DA, the center of the color filter and the center of the lens may be aligned or overlapped with the center of the opening OP of the corresponding pixel defining film PDL when viewed in the third direction DR3 (e.g., in a plan view). For example, in the central area of the display area DA, the opening OP of the pixel defining film PDL may completely overlap the corresponding color filter of the color filter layer CF and the corresponding lens of the lens array LA. In an area of the display area DA adjacent to the non-display area NDA, the center of the color filter and the center of the lens may be shifted in a planar direction from the center of the opening OP of the corresponding pixel defining film PDL when viewed in the third direction DR3 (e.g., in a plan view). For example, in an area of the display area DA adjacent to the non-display area NDA, the opening OP of the pixel defining film PDL may partially overlap the corresponding color filter of the color filter layer CFL and the corresponding lens of the lens array LA. Accordingly, in the center of the display area DA, light emitted from the light emitting structure EMS may be efficiently outputted in the normal direction of the display surface. Light emitted from the light emitting structure EMS at the outside of the display area DA may be efficiently outputted in a direction inclined by an angle (e.g., a set or predetermined angle) with respect to the normal direction of the display surface.

The overcoat layer OC may be located on the lens array LA. The overcoat layer OC may cover the optical functional layer OFL, the encapsulation layer TFE, the light emitting structure EMS, and/or the pixel circuit layer PCL. The overcoat layer OC may include various materials suitable for protecting lower layers thereof from foreign substances such as dust and moisture. For example, the overcoat layer OC may include at least one of an inorganic insulating film and an organic insulating film. For example, the overcoat layer OC may include an epoxy resin, but embodiments are not limited thereto. The overcoat layer OC may have a lower refractive index than the lens array LA.

The cover window CW may be located on the overcoat layer OC. The cover window CW is configured to protect lower layers thereof. The cover window CW may have a higher refractive index than the overcoat layer OC. The cover window CW may include glass, but embodiments are not limited thereto. For example, the cover window CW may be an encapsulation glass configured to protect constituent elements located thereunder. According to some embodiments, the cover window CW may be omitted.

FIG. 4 illustrates a block diagram of a connection relationship between a substrate and a controller according to some embodiments.

Referring to FIG. 4, the controller 150 may be located on a control circuit board CP, and the display panel 110, the gate driver 120, and data driver 130 may be located on the substrate SUB described in FIG. 2.

The display panel 110, the gate driver 120, the data driver 130, and the controller 150 of FIG. 4 are similar to the display panel 110, the gate driver 120, the data driver 130, and the controller 150 of FIG. 1, so redundant descriptions thereof are omitted.

The controller 150 may convert the input image data IMG to be suitable for the display panel 110 to generate the image data DATA.

The controller 150 may output the image data DATA to the data driver 130 through an interface. For example, the controller 150 may output the image data DATA to the data driver 130 through a low-voltage differential signaling (LVDS) interface.

FIG. 5 illustrates a top plan view of embodiments of FIG. 4.

Referring to FIG. 5, the control circuit board CP and the substrate SUB connected through a connection circuit board FC are illustrated. For convenience of illustration, the connection relationship between the display panel 110, the gate driver 120, and the data driver 130 is omitted.

The control circuit board CP may further include first pads PD1. The substrate SUB may further include second pads PD2. The second pads PD2 may be some of the pads PD in FIG. 2.

Referring to FIG. 2, the display panel 110 may be located in the display area DA of the substrate SUB, and the second pads PD2, the gate driver 120, and the data driver 130 may be located in the non-display area NDA of the substrate SUB.

The control circuit board CP and the substrate SUB may be connected through the connection circuit board FC. According to some embodiments, the control circuit board CP may be a printed circuit board, and the connection circuit board FC may be a flexible circuit board. In addition, according to some embodiments, the control circuit board CP may be formed of a silicon wafer substrate.

One end of the connection circuit board FC may be connected to the first pads PD1, and the other end of the connection circuit board FC may be connected to the second pads PD2. According to some embodiments, the connection circuit board FC may include a plurality of wires. One end of each of the plurality of wires may be connected to the first pads PD1, and the other end of each of the plurality of wires may be connected to the second pads PD2.

The controller 150 may output the image data DATA to the substrate SUB through the wires included in the connection circuit board FC.

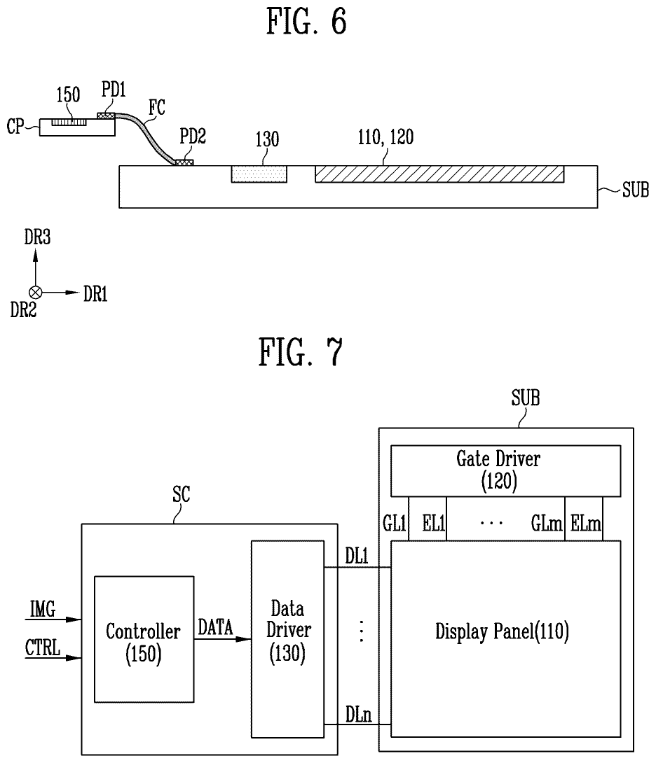

FIG. 6 illustrates a cross-sectional view of embodiments of FIG. 4.

Referring to FIG. 6, the control circuit board CP and the substrate SUB connected through the connection circuit board FC are illustrated.

The display panel 110, the gate driver 120, and the data driver 130 may be located on the substrate SUB. According to some embodiments, the gate driver 120 and the data driver 130 may be configured as separate integrated circuits, and may be located on the substrate SUB. For the convenience of the illustration, the display panel 110 and the gate driver 120 are shown to be configured as one circuit, but the gate driver 120 may be located on one side of the display panel 110.

The controller 150 may be located on the control circuit board CP. According to some embodiments, the controller 150 may be configured as an integrated circuit to be located on the control circuit board CP.

In addition, the first pads PD1 may be located on the control circuit board CP, and the second pads PD2 may be located on the substrate SUB. The first pads PD1 may be connected to one end of the connection circuit board FC, and the second pads PD2 may be connected to the other end of the connection circuit board FC.

FIG. 7 illustrates a block diagram of a connection relationship between a substrate and a controller according to some embodiments.

Referring to FIG. 7, the data driver 130 and the controller 150 may be located on a control substrate SC, and the display panel 110 and the gate driver 120 may be located on the substrate SUB described in FIG. 2.

The display panel 110, the gate driver 120, the data driver 130, and the controller 150 of FIG. 7 are similar to the display panel 110, the gate driver 120, the data driver 130, and the controller 150 of FIG. 1, so some redundant descriptions thereof may be omitted.

According to some embodiments, the substrate SUB and the control substrate SC may include a silicon wafer substrate formed using a semiconductor process. The control substrate SC may include a semiconductor material suitable for forming circuit elements. The control substrate SC may be manufactured in the form of a single chip formed of a silicon wafer substrate.

As the controller 150 and the data driver 130 are located on one substrate, the controller 150 may output the image data DATA to the data driver 130 without a separate interface. In this case, the signal outputted by the data driver 130 to the display panel 110 may be an analog signal.

According to some embodiments, the substrate SUB may further include a plurality of demultiplexers. The demultiplexers may be located between the data driver 130 and the display panel 110. The demultiplexers may output the signal outputted from the data driver 130 to a plurality of data lines through one channel.

As the interface for the controller 150 to output the image data DATA to the data driver 130 is omitted, power consumption for driving the interface may be relatively reduced.

However, as the controller 150 and the data driver 130 are located on one control substrate SC, the degree of freedom in designing the control substrate SC may be relatively reduced. For example, as the control substrate SC is manufactured in consideration of the arrangement structure of the data driver 130 and the display panel 110, the degree of freedom in designing the control substrate SC may be relatively reduced.

Even when the design or process for the controller 150 is modified, because the entire control substrate SC must be remanufactured rather than just the controller 150, the production cost of the control substrate SC may increase.

In addition, when the voltages of the power used by the controller 150 and the data driver 130 are different, the production cost of the control substrate SC may increase because a process for developing the controller 150 and the data driver 130 is required, respectively.

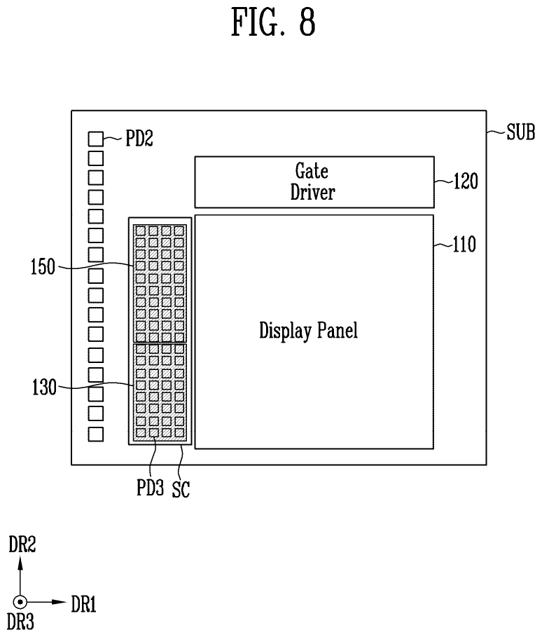

FIG. 8 illustrates a top plan view of embodiments of FIG. 7.

Referring to FIG. 8, the control substrate SC attached to the substrate SUB is illustrated. For convenience of illustration, the connection relationship between the display panel 110 and the gate driver 120 is omitted.

The substrate SUB may further include second pads PD2 and third pads PD3. The second pads PD2 and the third pads PD3 may be some of the pads PD of FIG. 2. The substrate SUB may be connected to an external substrate such as a flexible circuit board through the second pads PD2. The substrate SUB may be connected to the control substrate SC through the third pads PD3. That is, the control substrate SC may be attached to the substrate SUB in the vertical direction DR3 through the third pads PD3.

Referring to FIG. 2, the display panel 110 may be located in the display area DA of the substrate SUB, and the second pads PD2, the third pads PD3, and the gate driver 120 may be located in the non-display area NDA of the substrate SUB.

According to some embodiments, the third pads PD3 may be located on a first side surface of the display panel 110, and the gate driver 120 may be located on a second side surface of the display panel 110. The first and second side surfaces may be perpendicular to each other.

For example, the third pads PD3 and the display panel 110 may be located along the first direction DR1, and the display panel 110 and the gate driver 120 may be arranged along the second direction DR2.

According to some embodiments, when the substrate SUB further includes a plurality of demultiplexers, the third pads PD3, the demultiplexers, and the display panel 110 may be arranged along the first direction DR1.

Although FIG. 8 illustrates that the data driver 130 and the controller 150 are configured as separate integrated circuits, the present disclosure is not limited thereto, and they may be configured as one integrated circuit and located on the control substrate SC.

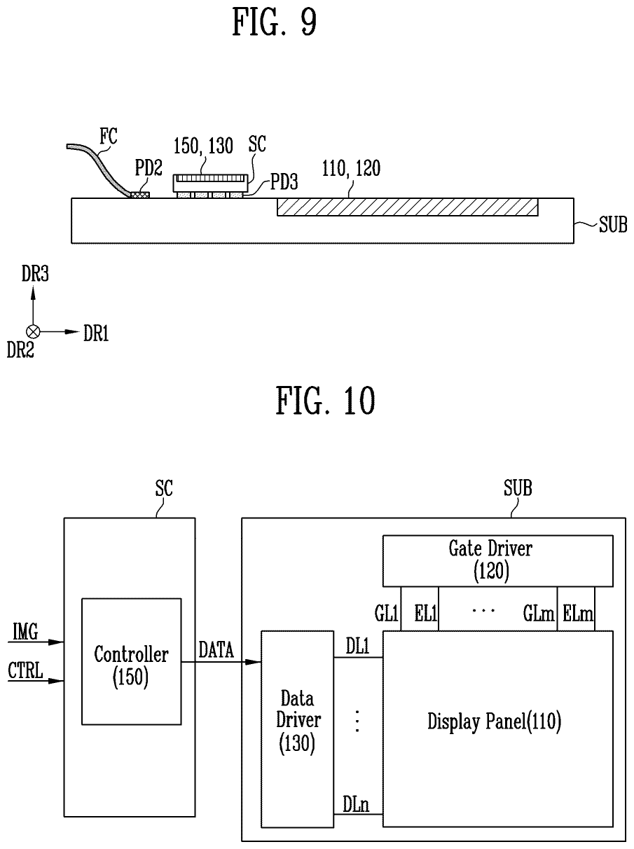

FIG. 9 illustrates a cross-sectional view of embodiments of FIG. 7.

Referring to FIG. 9, the control substrate SC and the substrate SUB connected through the third pads PD3 are illustrated.

The display panel 110 and the gate driver 120 may be located on the substrate SUB. For the convenience of the illustration, the display panel 110 and the gate driver 120 are shown to be configured as one circuit, but the gate driver 120 may be located on one side of the display panel 110.

The data driver 130 and the controller 150 may be located on the control substrate SC. According to some embodiments, the data driver 130 and the controller 150 may be configured as a single integrated circuit or may be configured as separate integrated circuits and located on the control substrate SC.

In addition, the second pads PD2 and the third pads PD3 may be located on the substrate SUB. The substrate SUB may be connected to another substrate through the second pads PD2 and the connection circuit board FC. The substrate SUB may be connected to the control substrate SC through the third pads PD3.

FIG. 10 illustrates a block diagram of a connection relationship between a substrate and a controller according to some embodiments.

Referring to FIG. 10, the controller 150 may be located on the control substrate SC, and the display panel 110, the gate driver 120, and data driver 130 may be located on the substrate SUB described in FIG. 2.

The display panel 110, the gate driver 120, the data driver 130, and the controller 150 of FIG. 10 are similar to the display panel 110, the gate driver 120, the data driver 130, and the controller 150 of FIG. 1, so some redundant descriptions thereof may be omitted.

According to some embodiments, the substrate SUB and the control substrate SC may be formed of a silicon wafer substrate formed using a semiconductor process.

As the controller 150 and the data driver 130 are arranged on separate substrates, the degree of freedom in designing the control substrate SC may be increased. For example, as the control substrate SC is manufactured without considering the arrangement structure of the data driver 130 and the display panel 110, the degree of freedom in designing the control substrate SC may be increased.

In addition, even if the voltages of the power used by the controller 150 and the data driver 130 are different, only the process for the development of the controller 150 is required without the process for the development of the data driver 130, so the production cost of the control substrate SC may be relatively reduced.

In addition, by attaching the control substrate SC to the substrate SUB, the controller 150 may output the image data DATA to the data driver 130 without a separate interface. Accordingly, as the interface for the controller 150 to output the image data DATA to the data driver 130 is omitted, power consumption for driving the interface may be relatively reduced. In this case, the image data DATA may be a digital signal.

According to some embodiments, the controller 150 and the data driver 130 may transmit and receive the image data DATA through serialization and deserialization. For example, the controller 150 may generate a matrix (or an object) by deserializing the image data DATA. The controller 150 may output the matrix to the data driver 130. The data driver 130 may serialize the received matrix and output it to the display panel 110. Through serialization and deserialization, the controller 150 may output the image data DATA to the data driver 130 even at a lower speed than before. Accordingly, the power consumed for transmitting and receiving the image data DATA may be relatively reduced.

According to some embodiments, the substrate SUB may further include a plurality of demultiplexers. The demultiplexers may be located between the data driver 130 and the display panel 110. The demultiplexers may output the signal outputted from the data driver 130 to a plurality of data lines through one channel.

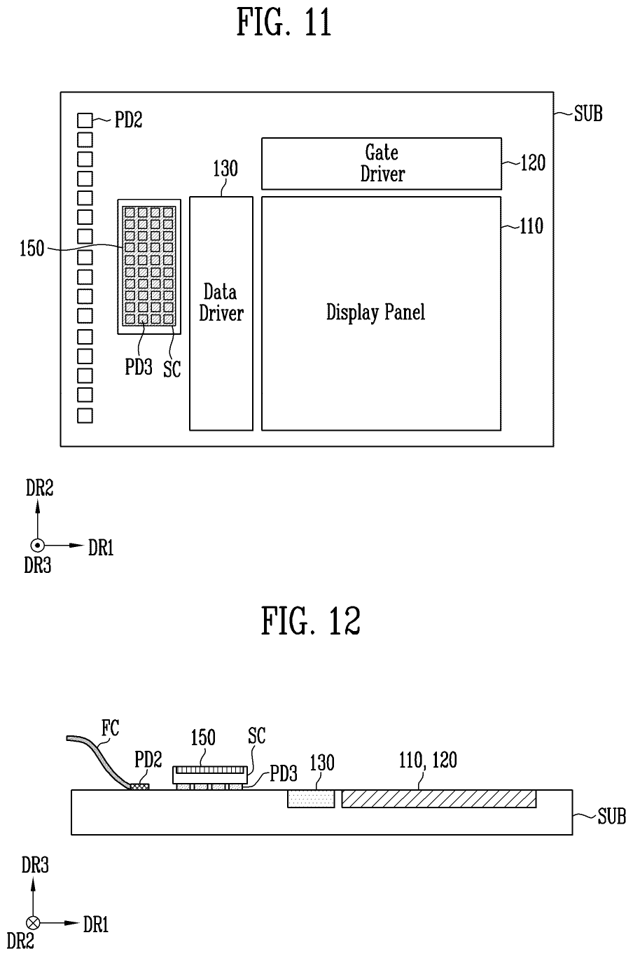

FIG. 11 illustrates a top plan view of embodiments of FIG. 10.

Referring to FIG. 11, the control substrate SC attached to the substrate SUB is illustrated. For convenience of illustration, the connection relationship between the display panel 110, the gate driver 120, and the data driver 130 is omitted.

Because the substrate SUB and the control substrate SC of FIG. 11 are similar to the substrate SUB and the control substrate SC of FIG. 10, some redundant descriptions thereof may be omitted.

The substrate SUB may further include the second pads PD2 and the third pads PD3. The second pads PD2 and the third pads PD3 may be some of the pads PD of FIG. 2. The substrate SUB may be connected to an external substrate such as a flexible circuit board through the second pads PD2. The substrate SUB may be connected to the control substrate SC through the third pads PD3. That is, the control substrate SC may be attached to the substrate SUB in the vertical direction DR3 through the third pads PD3. For example, the substrate SUB and the control substrate SC may be attached using a ball grid array (BGA) method. However, the present disclosure is not limited thereto, and the substrate SUB and the control substrate SC may be attached through a through-silicon via (TSV) or a hybrid bonding process.

Referring to FIG. 2, the display panel 110 may be located in the display area DA of the substrate SUB, and the second pads PD2, the third pads PD3, the gate driver 120, and the data driver 130 may be located in the non-display area NDA of the substrate SUB.

According to some embodiments, the third pads PD3 and the data driver 130 may be located on a first side surface of the display panel 110, and the gate driver 120 may be located on a second side surface of the display panel 110. The first and second side surfaces may be perpendicular to each other.

For example, the third pads PD3, the data driver 130, and display panel 110 may be arranged along the first direction DR1, and the display panel 110 and the gate driver 120 may be arranged along the second direction DR2.

According to some embodiments, when the substrate SUB further includes a plurality of demultiplexers, the third pads PD3, the data driver 130, the demultiplexers, and the display panel 110 may be arranged along the first direction DR1.

According to some embodiments, the third pads PD3 and the gate driver 120 may be located on a first side surface of the display panel 110, and the data driver 130 may be located on a second side surface of the display panel.

For example, the third pads PD3, the gate driver 120, and display panel 110 may be arranged along the first direction DR1, and the display panel 110 and the data driver 130 may be arranged along the second direction DR2.

The controller 150 may be configured as an integrated circuit to be located on the control substrate SC. However, the present disclosure is not limited thereto, and an external processor that outputs the input image data IMG and the control signal CTRL to the controller 150 and the controller 150 may be arranged together on the control substrate SC.

Referring to FIG. 11, the control substrate SC is illustrated as being located between the second pads PD2 and the data driver 130, but the present disclosure is not limited thereto, and it may be located on at least one of the first to fourth side surfaces of the display panel 110. The first and third side surfaces may be parallel to each other, and the second and fourth side surfaces may be parallel to each other.

In addition, according to some embodiments, the control substrate SC may be simultaneously located on the first and second side surfaces, simultaneously located on the third and fourth side surfaces, simultaneously located on the first and third side surfaces, or simultaneously located on the second and fourth side surfaces.

FIG. 12 illustrates a cross-sectional view of embodiments of FIG. 10.

Referring to FIG. 12, the control substrate SC and the substrate SUB connected through the third pads PD3 are illustrated.

Because the substrate SUB and the control substrate SC of FIG. 12 are similar to the substrate SUB and the control substrate SC of FIG. 10, some redundant descriptions thereof may be omitted.

The display panel 110, the gate driver 120, and the data driver 130 may be located on the substrate SUB. According to some embodiments, the gate driver 120 and the data driver 130 may be configured as separate integrated circuits, and may be located on the substrate SUB. For the convenience of the illustration, the display panel 110 and the gate driver 120 are shown to be configured as one circuit, but the gate driver 120 may be located on one side of the display panel 110.

The controller 150 may be located on the control substrate SC.

In addition, the second pads PD2 and the third pads PD3 may be located on the substrate SUB. The substrate SUB may be connected to another substrate through the second pads PD2 and the connection circuit board FC. The substrate SUB may be connected to the control substrate SC through the third pads PD3.

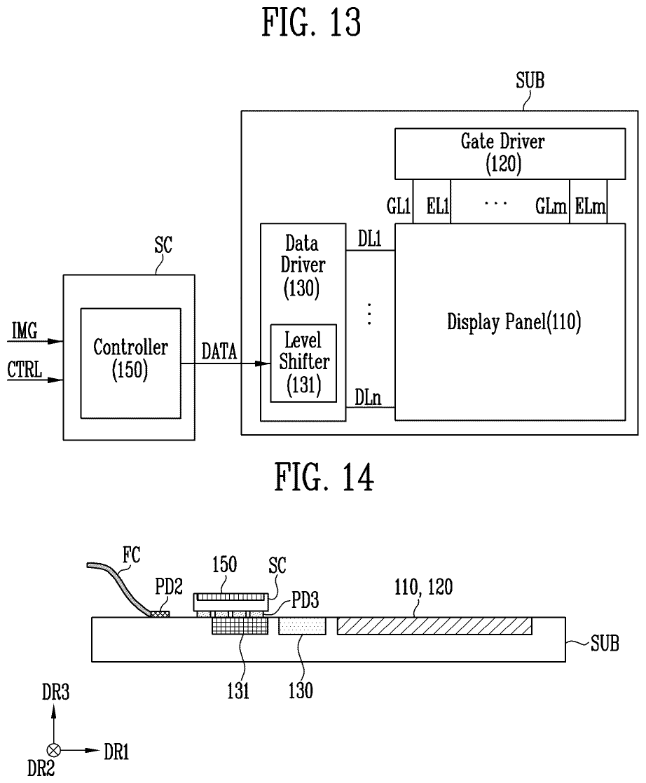

FIG. 13 illustrates a block diagram of a connection relationship between a substrate and a controller according to some embodiments.

Referring to FIG. 13, the controller 150 may be located on the control substrate SC, and the display panel 110, the gate driver 120, the data driver 130, and a level shifter 131 may be located on the substrate SUB described in FIG. 2. Referring to FIG. 2, the display panel 110 may be located in the display area DA of the substrate SUB, and the gate driver 120, the data driver 130, and the level shifter 131 may be located in the non-display area NDA of the substrate SUB.

The display panel 110, the gate driver 120, the data driver 130, and the controller 150 of FIG. 13 are similar to the display panel 110, the gate driver 120, the data driver 130, and the controller 150 of FIG. 10, so some redundant descriptions thereof may be omitted.

The data driver 130 may further include the level shifter 131. The controller 150 may output the image data DATA to the level shifter 131.

The level shifter 131 may change the voltage level of the image data DATA outputted from the controller 150 and output it to the data driver 130. In addition, the level shifter 131 may change the voltage level of the data control signal DCS outputted from the controller 150 and output it to the data driver 130.

In more detail, the data driver 130 may include the level shifter 131, a shift register, a sampling latch, and a holding latch.

The level shifter 131 may change the voltage levels of the image data DATA and the data control signal DCS received from the controller 150 and output them to the shift register and the sampling latch. The shift register may generate a sampling signal based on the data control signal DCS received from the level shifter 131. The sampling latch may store the image data DATA received from the level shifter 131 in response to the sampling signal. The holding latch may store the image data DATA supplied from the sampling latch.

That is, the image data DATA outputted from the controller 150 may be outputted to the display panel 110 through the level shifter 131, the sampling latch, and the holding latch in that order.

However, in embodiments different from FIG. 13, when the controller 150 and the data driver 130 are located together on the control substrate SC as shown in FIG. 7, the image data DATA outputted from the controller 150 may be outputted to the display panel 110 through the sampling latch, the holding latch, and the level shifter 131 in that order.

In FIG. 13, the level shifter 131 is described as being included in the data driver 130, but the present disclosure is not limited thereto, and in some embodiments, the level shifter 131 and the data driver 130 may be configured as separate integrated circuits.

FIG. 14 illustrates a cross-sectional view of embodiments of FIG. 13.

Because the substrate SUB and the control substrate SC of FIG. 14 are similar to the substrate SUB and the control substrate SC of FIG. 13, some redundant descriptions thereof may be omitted.

The display panel 110, the gate driver 120, the data driver 130, and the level shifter 131 may be located on the substrate SUB.

According to some embodiments, the gate driver 120 and the data driver 130 may be configured as separate integrated circuits, and may be located on the substrate SUB. For the convenience of the illustration, the display panel 110 and the gate driver 120 are shown to be configured as one integrated circuit, but the gate driver 120 may be located on one side of the display panel 110.

The level shifter 131 in FIG. 14 is illustrated as being configured as a separate integrated circuit from the data driver 130, but the present disclosure is not limited thereto, and the level shifter 131 may be included in the data driver 130. For example, the level shifter 131 and the data driver 130 may be configured as one integrated circuit.

In addition, the second pads PD2 and the third pads PD3 may be located on the substrate SUB. The substrate SUB may be connected to another substrate through the second pads PD2 and the connection circuit board FC. The substrate SUB may be connected to the control substrate SC through the third pads PD3.

According to some embodiments, the third pads PD3, the data driver 130, and the level shifter 131 may be located on a first side surface of the display panel 110, and the gate driver 120 may be located on a second side surface of the display panel 110.

The controller 150 may output the image data DATA to the level shifter 131 through the third pads PD3. The level shifter 131 may change the voltage level of the image data DATA outputted from the controller 150 and output it to the data driver 130.

Referring to FIG. 14, the control substrate SC and the level shifter 131 are illustrated as having an overlapping structure, but in some embodiments, the control substrate SC and the level shifter 131 may not overlap.

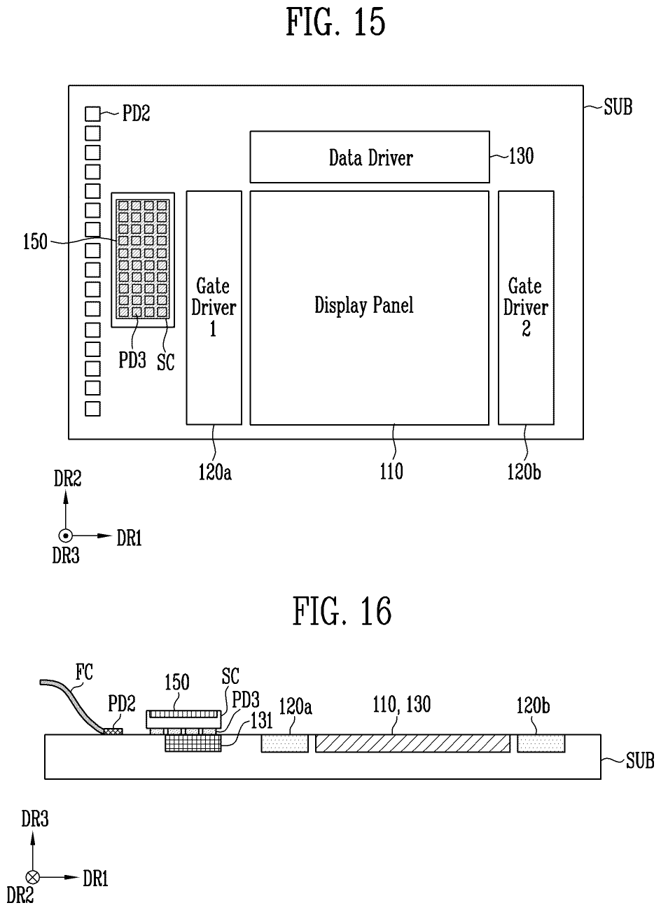

FIG. 15 illustrates a block diagram of a connection relationship between a substrate and a controller according to some embodiments.

Referring to FIG. 15, the control substrate SC attached to the substrate SUB is illustrated.

Because the substrate SUB and the control substrate SC of FIG. 15 are similar to the substrate SUB and the control substrate SC of FIG. 11, some redundant descriptions thereof may be omitted.

The gate driver 120 of FIG. 11 may include a first gate driver 120a and a second gate driver 120b of FIG. 15. That is, the first gate driver 120a and the second gate driver 120b of FIG. 15 may be physically and/or logically separate drivers from the gate driver 120 of FIG. 11.

According to some embodiments, the third pads PD3 and the first gate driver 120a may be located on the first side surface of the display panel 110, the data driver 130 may be located on the second side surface of the display panel 110, and the second gate driver 120b may be located on the third side surface of the display panel 110. The first and second side surfaces may be perpendicular to each other, and the first and third side surfaces may be parallel to each other. That is, the third side surface may be a side surface of the display panel 110 that is opposite to the first side surface.

For example, the third pads PD3, the first gate driver 120a, the display panel 110, and the second gate driver 120b may be arranged along the first direction DR1, and the display panel 110 and the data driver 130 may be arranged along the second direction DR2.

In addition, when the level shifter is configured as a separate integrated circuit from the data driver 130, the third pads PD3, the level shifter, and the first gate driver 120a may be located on the first side surface of the display panel 110, the data driver 130 may be located on the second side surface of the display panel 110, and the second gate driver 120b may be located on the third side surface of the display panel 110.

For convenience of illustration, the connection relationship between the display panel 110, the first gate driver 120a, the second gate driver 120b, and the data driver 130 is omitted.

In addition, according to some embodiments, the data driver 130 may include a first sub-data driver and a second sub-data driver. For example, the first sub-data driver, the display panel 110, and the second sub-data driver may be sequentially located according to the second direction DR2.

The arrangement structure of the display panel 110, the first gate driver 120a, the second gate driver 120b, and the data driver 130 in the substrate SUB of FIG. 15 may be different from the arrangement structure of the display panel 110, the gate driver 120, and the data driver 130 in the substrate SUB of FIG. 11.

More specifically, unlike in FIG. 11 in which the data driver 130 and the display panel 110 are arranged along the first direction DR1, in FIG. 15, the first gate driver 120a, the display panel 110, and the second gate driver 120b may be arranged along the first direction DR1.

That is, as only the controller 150 is located on the control substrate SC that is separate from the substrate SUB, the degree of freedom in arranging components of the substrate SUB (for example, the gate driver 120 and the data driver 130) may be relatively improved. Accordingly, components of the substrate SUB may be located in consideration of signal delay due to gate lines or data lines.

The substrate SUB may further include the second pads PD2 and the third pads PD3. The second pads PD2 and the third pads PD3 may be some of the pads PD of FIG. 2. The substrate SUB may be connected to an external substrate such as a flexible circuit board through the second pads PD2. The substrate SUB may be connected to the control substrate SC through the third pads PD3.

The controller 150 may be configured as an integrated circuit to be located on the control substrate SC.

FIG. 16 illustrates a cross-sectional view of embodiments of FIG. 15.

Because the substrate SUB and the control substrate SC of FIG. 16 are similar to the substrate SUB and the control substrate SC of FIG. 15, some redundant descriptions thereof may be omitted.

The display panel 110, the first gate driver 120a, the second gate driver 120b, and the data driver 130 may be located on the substrate SUB. According to some embodiments, the first gate driver 120a, the second gate driver 120b, and the data driver 130 may be configured as separate integrated circuits, and may be located on the substrate SUB. For the convenience of the illustration, the display panel 110 and the data driver 130 are shown to be configured as one integrated circuit, but the data driver 130 may be located on one side of the display panel 110.

The level shifter 131 in FIG. 16 is illustrated as being configured as a separate integrated circuit from the data driver 130, but the present disclosure is not limited thereto, and the level shifter 131 may be included in the data driver 130. For example, the level shifter 131 and the data driver 130 may be configured as one integrated circuit.

In addition, the second pads PD2 and the third pads PD3 may be located on the substrate SUB. The substrate SUB may be connected to another substrate through the second pads PD2 and the connection circuit board FC. The substrate SUB may be connected to the control substrate SC through the third pads PD3.

The controller 150 may output the image data DATA to the level shifter 131 through the third pads PD3. The level shifter 131 may change the voltage level of the image data DATA to output it to the data driver 130.

In more detail, the data driver 130 may include the level shifter 131, the shift register, the sampling latch, and the holding latch. The level shifter 131 may change the voltage level of the image data DATA received from the controller 150 and output it to the sampling latch and the holding latch.

Referring to FIG. 16, the control substrate SC and the level shifter 131 are illustrated as having an overlapping structure, but in some embodiments, the control substrate SC and the level shifter 131 may not overlap.

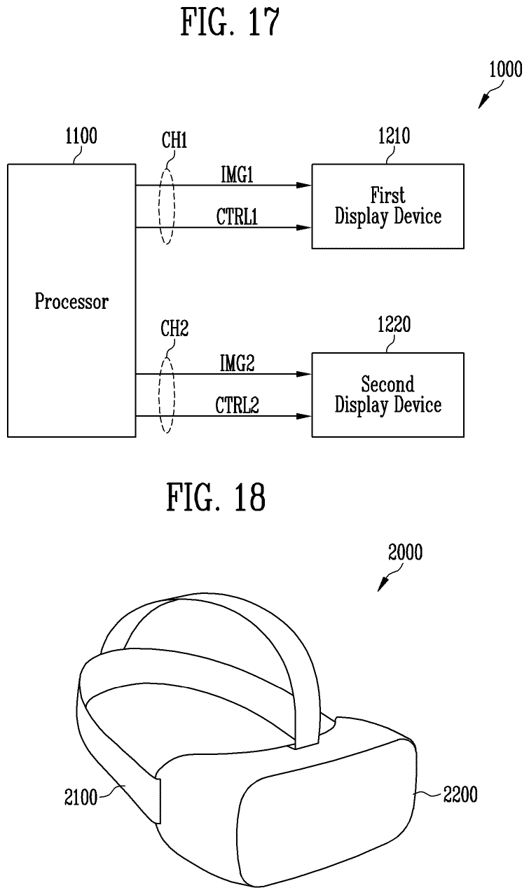

FIG. 17 illustrates a block diagram of a display system according to some embodiments.

Referring to FIG. 17, the display system 1000 may include a processor 1100 and one or more display devices 1210 and 1220.

The processor 1100 may perform various tasks and calculations. According to some embodiments, the processor 1100 may include an application processor, a graphics processor, a microprocessor, a central processing unit (CPU), and the like. The processor 1100 may be connected to and step other constituent elements of the display system 1000 through a bus system.

In FIG. 17, the display system 1000 is shown to include the first and second display devices 1210 and 1220. The processor 1100 may be connected to the first display device 1210 through a first channel CH1 and to the second display device 1220 through a second channel CH2.

Through the first channel CH1, the processor 1100 may transmit first image data IMG1 and a first control signal CTRL1 to the first display device 1210. The first display device 1210 may display an image based on the first image data IMG1 and the first control signal CTRL1. The first display device 1210 may be configured similarly to the display device 100 described with reference to FIG. 1. In this case, the first image data IMG1 and the first control signal CTRL1 may be provided as the input image data IMG and the control signal CTRL of FIG. 1, respectively.

Through the second channel CH2, the processor 1100 may transmit second image data IMG2 and a second control signal CTRL2 to the second display device 1220. The second display device 1220 may display an image based on the second image data IMG2 and the second control signal CTRL2. The second display device 1220 may be configured similarly to the display device 100 described with reference to FIG. 1. In this case, the second image data IMG2 and the second control signal CTRL2 may be provided as the input image data IMG and the control signal CTRL of FIG. 1, respectively.

The display system 1000 may include a computing system providing image display functions such as a portable computer, a mobile phone, a smart phone, a tablet personal computer (PC), a smart watch, a watch phone, a portable multimedia player (PMP), a navigation system, and a ultra mobile personal computer (UMPC). In addition, the display system 1000 may include at least one of a head-mounted display device (HMD), a virtual reality (VR) device, a mixed reality (MR) device, and an augmented reality (AR) device.

FIG. 18 illustrates a perspective view of an application example of the display system of FIG. 17.

Referring to FIG. 18, the display system 1000 of FIG. 17 may be applied to a head-mounted display device 2000. The head-mounted display device 2000 may be a wearable electronic device that may be worn on the user's head.

The head-mounted display device 2000 may include a head-mounted band 2100 and a display device accommodation case 2200. The head-mounted band 2100 may be connected to the display device accommodation case 2200. The head-mounted band 2100 may include a horizontal band and/or a vertical band for fixing the head-mounted display device 2000 to the user's head. The horizontal band may be configured to surround the side portion of the user's head, and the vertical band may be configured to surround the upper portion of the user's head. However, embodiments are not limited thereto. For example, the head-mounted band 2100 may be implemented in the form of a spectacle frame, a helmet, or the like.

The display device accommodation case 2200 may accommodate the first and second display devices 1210 and 1220 of FIG. 17. The display device accommodation case 2200 may further accommodate the processor 1100 of FIG. 17.

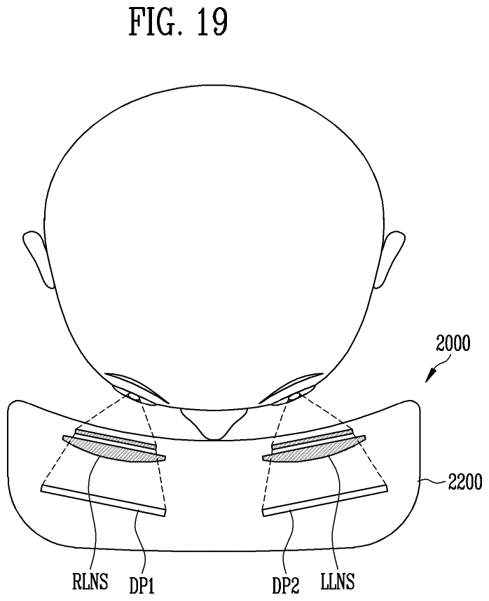

FIG. 19 illustrates a head-mounted display device worn on a user of FIG. 18.

Referring to FIG. 19, a first display panel DP1 of the first display device 1210 and a second display panel DP2 of the second display device 1220 are located in the head-mounted display device 2000. The head-mounted display device 2000 may further include one or more lenses LLNS and RLNS.

In the display device accommodation case 2200, the right eye lens RLNS may be located between the first display panel DP1 and the right eye of the user. In the display device accommodation case 2200, the left eye lens LLNS may be located between the second display panel DP2 and the left eye of the user.

An image outputted from the first display panel DP1 may be shown to the right eye of the user through the right eye lens RLNS. The right eye lens RLNS may refract light from the first display panel DP1 to be directed to the right eye of the user. The right eye lens RLNS may perform an optical function to adjust the viewing distance between the first display panel DP1 and the right eye of the user.

An image outputted from the second display panel DP2 may be shown to the left of the user through the left eye lens LLNS. The left eye lens LLNS may refract light from the second display panel DP2 to be directed to the left eye of the user. The left eye lens LLNS may perform an optical function to adjust the viewing distance between the second display panel DP2 and the left eye of the user.

According to some embodiments, each of the right eye lens RLNS and the left eye lens LLNS may include an optical lens having a cross-section of a pancake shape. In the embodiments, each of the right eye lens RLNS and the left eye lens LLNS may include a multi-channel lens including sub-areas with different optical characteristics. In this case, each display panel outputs images corresponding to the sub-areas of the multi-channel lens, and the output images may pass through the sub-areas and be viewed by the user.

Although certain embodiments and implementations have been described herein, other embodiments and modifications will be apparent from this description. Accordingly, embodiments according to the present disclosure are not limited to the disclosed embodiments, but rather to the broader scope of the presented claims and various modifications and equivalent arrangements.

What is claimed is:

1. A display device comprising:
a substrate including a display panel configured to display an image corresponding to image data, a data driver configured to apply a plurality of data signals corresponding to the image data to the display panel, a level shifter configured to change a voltage level of the image data, and first pads; and
a control substrate including a controller configured to output the image data to the level shifter, and attached to the substrate in a vertical direction through the first pads.

2. The display device of claim 1, wherein the data driver and the level shifter are configured as one integrated circuit.

3. The display device of claim 1, wherein the substrate further includes a gate driver configured to apply a plurality of gate signals to the display panel.

4. The display device of claim 3, wherein the substrate includes a display area in which the display panel is located and a non-display area in which the first pads, the data driver, the gate driver, and the level shifter are located.

5. The display device of claim 3, wherein
the first pads, the level shifter, and the data driver are on a first side surface of the display panel,
the gate driver is on a second side surface of the display panel, and
the first side surface and the second side surface are perpendicular to each other.

6. The display device of claim 3, wherein
the first pads, the level shifter, and the gate driver are on a first side surface of the display panel,
the data driver is on a second side surface of the display panel, and
the first side surface and the second side surface are perpendicular to each other.

7. The display device of claim 6, wherein
the gate driver includes a first sub-gate driver and a second sub-gate driver,
the first pads, the level shifter, and the first sub-gate driver are on the first side surface,
the data driver is on the second side surface,
the second sub-gate driver is on a third side surface of the display panel,
the second side surface and the third side surface are perpendicular to each other, and
the first side surface and the third side surface are parallel to each other.

8. The display device of claim 1, wherein the data driver includes a sampling latch and a holding latch, and
the image data is output to the display panel through the level shifter, the sampling latch, and the holding latch in that order.

9. The display device of claim 1, wherein the image data output by the controller to the level shifter is a digital signal.

10. The display device of claim 1, wherein the control substrate is formed as a silicon wafer substrate.

11. A display device comprising:
a substrate including a display panel configured to display an image corresponding to image data, and first pads on a first side surface of the display panel;
a control substrate including a data driver configured to apply a plurality of data signals corresponding to the image data to the display panel and a controller configured to output the image data to the data driver,
wherein the control substrate is attached to the substrate in a vertical direction through the first pads; and
a gate driver is on a second side surface of the display panel, wherein
the first side surface and the second side surface are perpendicular to each other.

12. The display device of claim 11, wherein
the control substrate is formed as a silicon wafer substrate.

13. The display device of claim 11, wherein
the controller and the data driver are configured as one integrated circuit.

14. The display device of claim 11, wherein
the gate driver is configured to apply a plurality of gate signals to the display panel.

15. The display device of claim 14, wherein
the substrate includes a display area in which the display panel is located and a non-display area in which the first pads and the gate driver are located.

16. The display device of claim 11, wherein
the substrate further includes a level shifter,
the data driver includes a sampling latch and a holding latch, and
the image data is outputted to the display panel through the sampling latch, the holding latch, and the level shifter in that order.

17. A display device comprising:
a substrate including a display panel configured to display an image corresponding to image data and a data driver configured to apply a plurality of data signals corresponding to the image data to the display panel;
a control circuit board including a controller configured to output the image data to the data driver; and
a connection circuit board configured to connect the substrate and the control circuit board.

18. The display device of claim 17, wherein
the substrate further includes first pads,
the control circuit board further includes second pads, and
one end of the connection circuit board is connected to the first pads and the other end of the connection circuit board is connected to the second pads.

19. The display device of claim 17, wherein
the control circuit board is formed as a silicon wafer substrate.

20. The display device of claim 17, wherein
the control circuit board is a printed circuit board, and the connection circuit board is a flexible circuit board.
